(19) United States
(12) Patent Application Publication
(10) Pub. No.: US 2007/0006276 A1
(43) Pub. Date: Jan. 4, 2007

(54) Audiovisual playback

(75) Inventors: Alexis S.R. Ashley, Redhill (GB); Immo Benjes, Redhill (GB); Jonathan C. Foster, Bradford-On-Avon (GB); Richard J. Houldsworth, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/556,452

(22) PCT Filed: May 10, 2004
(86) PCT No.: PCT/IB04/01545

§ 371 Date: Nov. 10, 2005

(30) Foreign Application Priority Data
May 15, 2003 (GB) 0311140.8

(51) Int. Cl. H04N 7/173; H04N 7/16

(52) U.S. Cl. 725/134; 725/142; 725/89

(57) ABSTRACT

A method of playing back audiovisual content together with associated application content, is described, for example using an extended DVD system to play back MHP broadcast content including the inter-active content. The DVD disk includes at least partially an MHP API to enhance the capabilities of a DVD player.

The invention relates to a method of outputting recorded audiovisual content, in particular combined with applications, for example providing interactive content.

Interactive television requires the delivery of audiovisual content as well as applications capable of responding to user input. Open protocols for the provision of and playback of interactive TV are essential for the widespread adoption of interactive TV.

One standard is the Multimedia Home Platform (MHP), which is directed at interactive broadcast material. In this standard, already introduced in several countries around the world, sophisticated applications may be broadcast together with audiovisual content. An Application Information Table is broadcast to signal MHP applications. However, this standard does not address the issue of storing such content on removable media such as digital versatile disks (DVDs).

MHP is by no means the only interactive TV system by which applications may be provided with broadcast content. Others include OpenTV, MediaHighway and MHEG-5.

A recent standard is the digital storage media—command and control (DSM-CC) standard, which defines standards for messages and sessions.

When broadcast interactive TV transmissions are received on a suitable receiver, the incoming transmission stream is searched for application data, and application data may be stored in memory. When the user presses appropriate buttons on his or her remote control or other data entry means, the applications are run. An example of the caching that may take place is described in U.S. Pat. No. 6,427,238 assigned to OpenTV, Inc.

However, when a conventional DVD video recorder records such material, it is only able to play back the audiovisual component of the transmitted MHP stream, not additional applications for example implementing the interactive functionality. There is thus a need for a way to play back recorded interactive TV transmissions.

According to the invention, there is provided a method of outputting interactive audiovisual content stored on a removeable storage medium storing audiovisual content, a control application and at least one additional linked application in a predetermined interactive television platform independent standard, including the steps of:

starting a control application stored on the removeable storage medium;

calling the audiovisual display application from the control application;

reading audiovisual data from the removeable storage medium using the audiovisual display application and providing an audiovisual display based on that content;

calling at least one linked application from the control application to execute the or each linked application;

wherein the control application stored on the removeable storage medium implements part of the functionality of the interactive television predetermined platform independent standard including at least part of an application programming interface of the predetermined platform independent standard; and

the at least one linked application calls the application programming interface of the predetermined platform independent standard when executing.

In this way, a player can reproduce interactive audiovisual content even when the player itself is not able to fully implement the platform-independent standard, or does not do so at all.

Note that the audiovisual display application and the at least one additional linked application can be started by the control application in any order as required.

Preferably the control application implementing at least part of the functionality of the predetermined interactive television platform independent standard is written in a computer platform independent standard. This latter standard may be java byte code or other code that may be interpreted by the player.

To identify the linked applications, an application information table may be provided. The control application may read an application information table stored on the removeable storage medium and call the at least one linked application based on the information in the application information table.

In a preferred arrangement, the at least one additional linked application is an MHP application and the control application implements at least partially the MHP application programming interface. The removeable storage medium may be a DVD disk and the audiovisual display application a DVD-video reader for reading DVD-Video content from the disk.

Although a DVD player may not have the functionality to implement broadcast application formats such as MHP the control application stored on the disk provides the necessary additional functionality.

Preferably, the audiovisual display application determines when specified events occur and calls back from the audiovisual display application to the control application when one or more of the specified events occur. In this way, the control application may start or stop linked applications as required at particular times in the audiovisual presentation.

In another aspect, the invention relates to a computer program for causing a player to carry out the steps of a method set out above.

The invention also relates to a removeable storage medium, including: audiovisual content; application code in a predetermined platform independent standard; and a control application for calling the application code and for calling a virtual machine to display the audiovisual content; wherein the removeable storage medium includes at least a part of an application programming interface for the predetermined platform independent standard, so that the application code calls the part of the application programming interface to implement that least some of the functionality of the platform independent standard.

A preferred embodiment of the invention will now be described, purely by way of example, with reference to the accompanying drawings, in which:

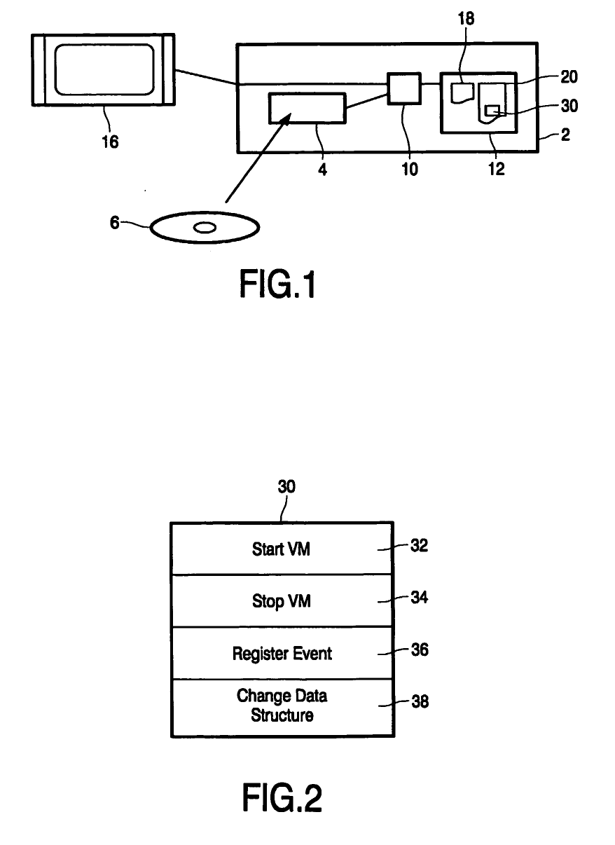

FIG. 1 illustrates an extended DVD player suitable for use with the invention;

FIG. 2 illustrates the enhanced DVD API;

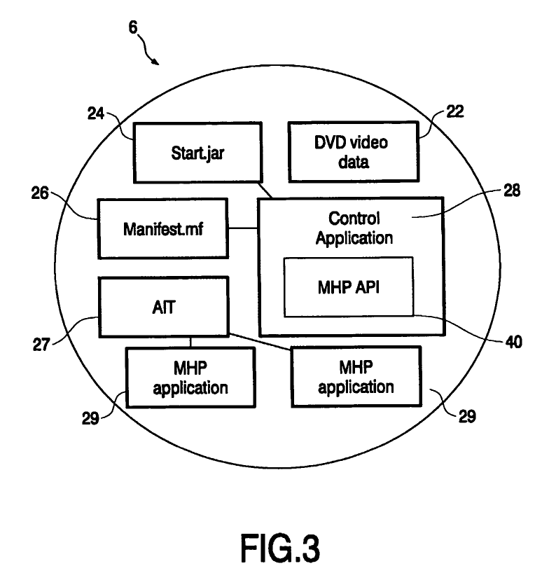

FIG. 3 illustrates a recorded DVD disk; and

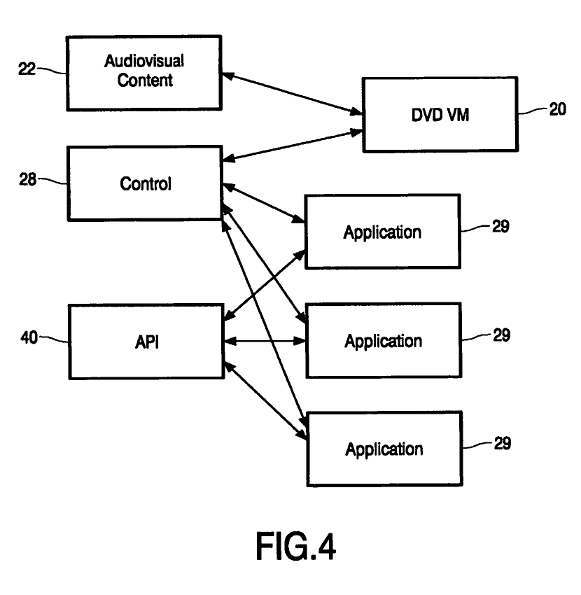

FIG. 4 schematically illustrates program control.

The invention relates principally to the playback of recorded interactive TV transmissions.

In a specific example, playback is carried out on an extended DVD playback reader that will now be described.

A DVD video recorder/player 2 includes a DVD reader 4 for reading a removable storage medium in the form of a DVD disk 6 inserted into the recorder/player 2. The DVD video recorder/player 2 also includes a processor 10 and memory 12. The DVD video recorder/player may also have a number of other components, such as a remote control 14 in the case of a stand-alone recorder/player. If the DVD video recorder/player 2 is instead implemented on a conventional personal computer, the remote control 14 may be replaced by a keyboard and a mouse or an alternative data input system as is well known.

The DVD video recorder/player 2 is connected to an audiovisual reproduction system 16 such as a conventional television. As will be well appreciated by those skilled in the art, the audiovisual reproduction system may be much more complex than a simple television and include surround sound decoders, multichannel amplifiers and many other types of component.

The memory 12 includes code 18 for implementing a platform independent virtual machine in the DVD recorder/player 2. By a “virtual machine” is meant a system capable of implementing standard instructions, to allow programs to be implemented in a platform-independent manner. In the specific example now described the virtual machine is a Java virtual machine 18 which allows the DVD video recorder/player to execute Java byte-code. MHP applications use Java byte-code, for example. However, as the skilled person will appreciate, other platform independent codes exist, for example OpenTV applications use o-code, and these may alternatively or additionally be used.

The memory 12 also includes code 20 implementing a DVD-V virtual machine. Much of the functionality of this is standard and allows the DVD video recorder/player 2 to simply play back audiovisual DVD video content, access menus using the remote control 14, and carry out all the standard functions of a DVD video recorder/player.

In the preferred embodiment, the DVD VM 20 is implemented in the platform independent code of the platform independent virtual machine 18. This makes communication between the DVD VM 20 and external applications running in the platform independent virtual machine 18 straightforward. However, the skilled person will be aware of how to communicate between processes running on different applications in the same DVD recorder/player so it is not essential that the DVD VM runs in the same platform independent virtual machine 18.

The DVD VM 20 includes an application programming interface (API) 30 that gives the DVD video recorder/player 2 enhanced functionality. FIG. 2 illustrates the components of the DVD VM API 30 that may be separately called to access the functionality of the DVD VM 20.

The API exposes the structure of the DVD-video data and the virtual machine in that calls to the API can be used to access the data, including the cells, the video objects and the various other standard parts of DVD video data. Calls to the API can be used to carry out the following functions:

(1) Start 32 the VM, i.e. start the decoding of DVD video;

(2) Stop 34 the VM;

(3) Register 36 specified events with the VM, for example a particular position in the DVD-video data, such as a particular cell being reached or a particular option being selected in a particular menu; and

(4) to change the menus 38 to be displayed by the VM.

It will be appreciated that this need not be a complete list and other functionality may be provided if required, for example to provide other ways of changing data structures other than simply to change the menus.

The DVD VM 20 also has the capability to return processing back to the program that called the DVD VM API 30 when the specified events occur. In general, these will be the events previously registered by a call to the DVD VM API 30, but other events may also cause a call back, for example reaching the end of the DVD video data.

A DVD disk 6 containing recorded information from an MHP stream is illustrated schematically in FIG. 3.

The DVD includes video data 22 and additionally a Java archive file (.jar file) 24 with a standard name, for example start.jar, stored in the UDF/ISO file system of the DVD. The archive file stores a number of files including a manifest file 26, as is conventional in Java archives, called META_INF/MANIFEST.MF, which includes the location of the autostart control application file 28. The applications such as the control application are thus stored in a computer standard platform independent code, here java byte code. Other suitable computer standard platform independent codes may also be used, as long as these can be interpreted by the player 2.

The DVD also stores one or more MHP applications 29, i.e. code and data in a hierarchical file system. The code provides additional functionality, and in particular may be used to provide interactive TV functionality. In the specific embodiment, the MHP applications are recorded in digital storage media—command and control DMS-CC message format.

The archive also includes a representation of an Application Information Table (AIT) 27 as used in MHP broadcast environments to signal an MHP application. The AIT identifies the MHP application 29 and starting parameters. The AIT is interpreted by the control application 28 contained in the Java archive file.

As illustrated in FIG. 4, the control application 28 controls the playback of a recorded interactive audiovisual presentation, i.e. the playback of audiovisual content together with associated applications. It calls the DVD VM 20 to display audiovisual content and calls the MHP applications 29 as and when required. The DVD VM 20 in turn obtains audiovisual data 22 from the disk and the or each MHP application 29 calls the MHP API 40 to implement MHP functionality.

In the specific embodiment, the code implementing the MHP API 40 used to access MHP functionality is also stored on the disk, conveniently in java byte code or other machine readable format.

On inserting the DVD disk 6 into the reader the Java archive file 24 is decompressed and the Jar manifest is used to run the control application 28 with suitable parameters. This control application 28 will be run on the Java virtual machine 18 in the DVD video recorder/player 2.

The control application 28 calls the DVD video API to register events. In particular, it calls the DVD video API to register as events occasions when the control application 28 needs to take action, for example to start or stop one of the MHP applications 29.

As will be appreciated, many MHP applications are autostart applications and so the control application 28 will start one instance of each autostart MHP application 29 as indicated in the AIT 27.

The MHP applications in this example run on the Java virtual machine 18 but require additional functionality. To provide this functionality, when running, the MHP applications 29 will call the MHP API 40 to access this functionality as and when required.

After these initial steps, the control application 28 then calls the DVD video API to start the DVD VM 20 playing back the audiovisual data 22. When the DVD VM 20 passes one of the registered events, control is passed back from the DVD VM 20 to the control application 28 to allow the control application 28 to process the event.

In particular, some of the events will start MHP applications 29. For example, an originally broadcast MHP signal may include a control application at a particular point in the audiovisual presentation. This is reproduced in the recorded version by arranging for the control application to register that particular point in the audiovisual presentation as an event. When that point is reached, the DVD VM 20 passes control back to the control application 28 which starts the MHP application 29, thereby obtaining the effect of the original MHP broadcast.

Other events may indicate a version change in the MHP application file system. For example, if during the original broadcast a file in the broadcast filesystem changed version, this is reproduced in the recorded version by an event in the audiovisual data stream. When this event is reached, the DVD VM 20 passes control back to the control application, which updates its decoder for the MHP application filesystem, such that the correct version of the file is made visible to the MHP application.

In some cases, it will be desired to stop the DVD VM, and this can be carried out by a suitable call to the DVD VM API 30 from the control application 28. In other cases, it is desired that the DVD VM 20 simply carries on. This will all be available under the control of the MHP application 29, which can call the control application 28 through API 40 to cause the control application to process the request in accordance with the MHP standard which may in turn require the control application 28 to call the DVD VM API 30 with the correct parameters to start or stop or otherwise control the audiovisual playback.

After processing an event, control may pass back to the DVD VM 20 to continue DVD video playback. The MHP application 29 may run concurrently, for example waiting for a user input. On receiving such user input, the MHP application may then call the MHP API 40 implemented in the control application 28 to request, for example, the audiovisual playback to cease, which is accomplished by calling the DVD VM API 30.

Note that in alternative embodiments the amount of functionality provided on the DVD disk 6 may vary. In particular, the control application 28 needs to have access to processing of DMS-CC data, to DVB service information providing TV information, and other features. This functionality may be provided either in control application 28 code stored on the DVD disk 6, or in code stored in the player 2 itself. For example, the player 2 may include a Java virtual machine and API set matching Personal Basis Profile (a Java 2 Micro Edition specification providing basic I/O and graphics APIs), which would implement most of the graphics requirements of an MHP application, but would leave DSMCC and SI processing to the control application 28. In this case, much of the functionality of the MHP API 40 would be implemented by code stored on the player. However, the DMS-CC functionality and the SI functionality is still provided on code stored on the disk.

The MHP API 40 needs to implement a number of functions. As well as the DSMCC API discussed above, MHP requires other APIs, such as the service information API which provides TV program information, which can be emulated by the control application 28 in various ways. For example, the service information API can parse the data recorded in the audiovisual stream, or simply report the contents of a file on disk created when the recording was started.

Thus, the control application 28 and the player 2 together provide an MHP API 40, which the MHP application 29 sees as implementing all MHP functionality.

Note that the control application 28 in turn calls the DVD VM 20 to implement part of the functionality it provides to the MHP application 29. Thus, the control application acts to mimic the broadcast environment to the MHP application.

Thus, the functionality to provide interactive playback is provided by the interaction of the MHP application, the control application and the DVD VM accessing each other through the DVD VM API and the MHP API.

Thus far, the description has concentrated on play back which forms the focus of the present invention. There are a number of different possibilities for recording audiovisual data including interactive TV applications on the disk in the first place. This is not a wholly trivial task, because the files seen by an application differs from a fixed file system on a disk in two important respects. Firstly, the files can change over time, and new versions of a file can appear at any time. Secondly, the file system seen contains non-directory, non-file objects, which may reference stream events, the media streams or a timebase.

There are several possible approaches to deal with these issues.

In a first approach, the filesystem is simply stored as a UDF filesystem as it exjsts on a player at a single point in time. Stream objects are stored in a special file which is decoded at playback. This approach has the merit of simplicity, but as will be appreciated, does not address all of the issues since the recorded filesystem is fixed and does not change with time. Therefore, the approach will not work with all applications, in particular the approach will not work where the available recorded applications change with time.

In a second approach, the complete broadcast stream of DMSCC message is stored on disc and simply decoded as if the stream was broadcast. This is very wasteful in terms of disk space and decoder cost.

In a third approach, only new versions of DSMCC messages are stored, and a database is maintained of the validity period of each message. A decoder needs to reference the database to pull back the appropriate messages based on the current time referenced to the audiovisual time.

The invention is intended to playback MHP recorded using any of these approaches.

The invention is of particular applicability to combined DVD/MHP recorder/players but may be applied to any suitable recorder/player. The DVD disk 6 may be replaced by a compact disk (CD) or other removeable storage medium such as flash memory as required for any particular application. In particular, the invention may be of use in implementing a combined MHP/CD file system.

In the above example, both the control application and the linked application are coded to the same virtual machine standard, (a Java virtual machine) and the control application 28 simply adds additional functionality through API 40.

In alternate embodiments, the control application may need to provide more support. For example, a sufficiently expressive virtual machine can support control applications that emulate a different virtual machine environment.

In a second embodiment, MHEG-5 applications 29 (used in “Freeview” broadcasts in the UK) are stored on the disk. A Java control application 28 emulates the complete MHEG-5 API runtime environment, and the linked MHEG-5 application is interpreted instruction-by-instruction by the control application. Thus in this case control application 28 acts as a complete interpreter.

From reading the present disclosure, other variations and modifications will be apparent to persons skilled in the art. Such variations and modifications may involve equivalent and other features which are already known in the design, manufacture and use of audiovisual players and broadcast systems and which may be used in addition to or instead of features described herein.

Although claims have been formulated in this application to particular combinations of features, it should be understood that the scope of disclosure also includes any novel feature or any novel combination of features disclosed herein either explicitly or implicitly or any generalisation thereof, whether or not it mitigates any or all of the same technical problems as does the present invention. The applicants hereby give notice that new claims may be formulated to any such features and/or combinations of such features during the prosecution of the present application or of any further applications derived therefrom.

In particular, the embodiment described relates to an MHP system but the skilled person will realise that other standards exist and that the invention may be implemented using these alternative standards.

Further, although the above description refers to a “control application 28” as a unitary application, in practice the control application may be made up of a number of separate routines and modules that may be loaded as and when required.

1. A method of outputting from a player (2) interactive audiovisual content stored on a removeable storage medium storing audiovisual content, a control application and at least one additional linked application in a predetermined interactive television platform independent standard, including the steps of:
starting a control application (28) stored on the removeable storage medium (6);
calling the audiovisual display application (20) from the control application (28);
reading audiovisual data from the removeable storage medium using the audiovisual display application (20) and providing an audiovisual display based on that content;
calling at least one linked application (29) from the control application (28) to execute the or each linked application (29);
wherein the control application (28) stored on the removeable storage medium (6) implements part of the functionality of the interactive television predetermined platform independent standard including at least part of an application programming interface (40) of the predetermined platform independent standard; and
the at least one linked application (29) calls the application programming interface (40) of the predetermined platform independent standard when executing.

2. A method according to claim 1 wherein the control application (28) implementing at least part of the functionality of the predetermined interactive television platform independent standard is written in a computer platform independent standard.

3. A method according to claim 1 wherein the control application (28) reads an application information table (27) stored on the removeable storage medium (6) and calls the at least one linked application (29) based on the information in the application information table (27).

4. A method according to claim 1 further including
registering specified events with the audiovisual display application (20); and
calling back from the audiovisual display application (20) to the control application (28) when one or more of the specified events occur.

5. A method according to claim 1 wherein the predetermined interactive television platform independent standard is MHP.

6. A method according to claim 1, wherein the disk is a DVD disk and the audiovisual display application (20) is a DVD-video reader for reading DVD-Video content from the disk.

7. A method according to claim 1, wherein the control application (28) acts as an interpreter to interpret the code of the linked applications.

8. A removeable storage medium (6), including
audiovisual content (22);
application code (29) in a predetermined interactive television platform independent standard; and
a control application (28) for calling the application code (29) and for calling a virtual machine (20) to display the audiovisual content;
wherein the control application (28) implements part of the functionality of the interactive television predetermined platform independent standard including at least part of an appication programming interface (40) of the predetermined platform independent standard, so that the application code (29) calls the part of the application programming interface (40) to implement that least some of the functionality of the interactive television platform independent standard.

9. A removeable storage medium (6) according to claim 8 wherein the interactive television platform independent standard is MHP.

10. A removeable storage medium according to claim 8 wherein the removeable storage medium (6) is a DVD disk.
